(19) United States
(12) Patent Application Publication
(10) Pub. No.: US 2002/0150868 A1
(43) Pub. Date: Oct. 17, 2002

(54) Remote learning method and remote learning control apparatus

(76) Inventors: Yasuji Yui, Kanagawa (JP); Chika Miura, Tokyo (JP)

Correspondence Address: COOPER & DUNHAM LLP, 1185 Avenue of the Americas, New York, NY, 10036, US

(21) Appl. No.: 09/947,792

(22) Filed: Sep. 7, 2001

(30) Foreign Application Priority Data
Sep. 8, 2000 (JP) P2000-273954

(51) Int. Cl. G09B 19/00

(52) U.S. Cl. 434/156

(57) ABSTRACT

This invention is intended to enable a learner to efficiently learn a language or the like while using an information terminal such as a personal computer apparatus.

### BACKGROUND OF THE INVENTION

1. Field of the Invention

The present invention relates to a remote learning method applied to a learning system for allowing a learner to learn a language or the like at a remote place through a predetermined network, and to a remote learning control apparatus used as a control apparatus for the remote learning method.

2. Description of the Related Art

There has been provided hitherto an opportunity for a learner to learn a language such as English using a personal computer. For example, a learning software in which a lot of voice data on the pronunciations of English words are stored is installed into a personal computer apparatus and executed. Then, the pronunciations of the words stored in the software are outputted as voices, a user (or learner) is instructed to type these words. The computer determines whether or not corresponding words are correctly inputted based on the input of the characters by typing, displays a correct answer rate and allows the user to memorize the words.

Here, if there is prepared such an environment as to connect a personal computer apparatus to the Internet using a telephone line or the like, a predetermined server provides a learning program through the Internet and the server can determine a program execution result.

If the user of the computer apparatus learns a language or the like in accordance to an instruction from the server using the network such as the Internet stated above, the user is not needed to prepare a learning software in advance to thereby make it possible for the user to easily learn the language or the like.

Meanwhile, whether or not a word pronounced by the user is typed correctly is simply determined in case of the language learning using the above-stated conventional computer apparatus. It is, therefore, difficult to provide more advanced learning.

The present invention has been made in view of the above respects. It is, therefore, an object of the present invention to enable a user or a learner to efficiently learn a language or the like using an information terminal such as a personal computer apparatus.

### SUMMARY OF THE INVENTION

According to the present invention, voice data stored in a language learning voice file on a center side is transmitted to a terminal of each learner through a predetermined communication line; if voice in the voice data received by the terminal is outputted and then an operation for inputting characters corresponding to the voice is carried out, reply data generated based on the input operation for the corresponding characters is transmitted to the center through the communication line; and a learning ability of the learner is totalized from time required since the voice data is transmitted from the center until the reply data is transmitted and a correct answer rate of the character input operation.

By doing so, it is possible to determine the learning ability of each learner from two elements, i.e., time required since the learner listens to the voice until characters are inputted and a correct answer rate in the character input operation.

### BRIEF DESCRIPTION OF THE DRAWINGS

FIG. 1 is an explanatory view showing an example of a system configuration in one embodiment according to the present invention;

FIG. 2 is a flow chart showing an example of a learning processing in the embodiment according to the present invention;

FIG. 3 is an explanatory view showing an example of a screen displayed on a terminal apparatus in the embodiment according to the present invention;

FIG. 4 is an explanatory view showing an example of a screen displayed on a terminal apparatus in the embodiment according to the present invention;

FIG. 5 is an explanatory view showing an example of reply data in the embodiment according to the present invention;

FIG. 6 is an explanatory view showing an example of grouping in the embodiment according to the present invention; and

FIG. 7 is an explanatory view showing an example of a quizzes in the embodiment according to the present invention.

### DETAILED DESCRIPTION OF THE PREFERRED EMBODIMENTS

One embodiment of the present invention will be described hereinafter with reference to the accompanying drawings.

In this embodiment, a terminal unit installed for an individual learner is connected to a language learning service server prepared in a predetermined center through the Internet by way of a communication line such as a telephone line, a cable television line or a radio line so that the learner can learn a language in accordance with an instruction from the language learning service server. To be specific, the learner learns dictation by making a learner output the voice of, for example, an English word from a learner-side terminal unit, type and input the characters of the word indicated by the voice, i.e., pronunciation using a keyboard.

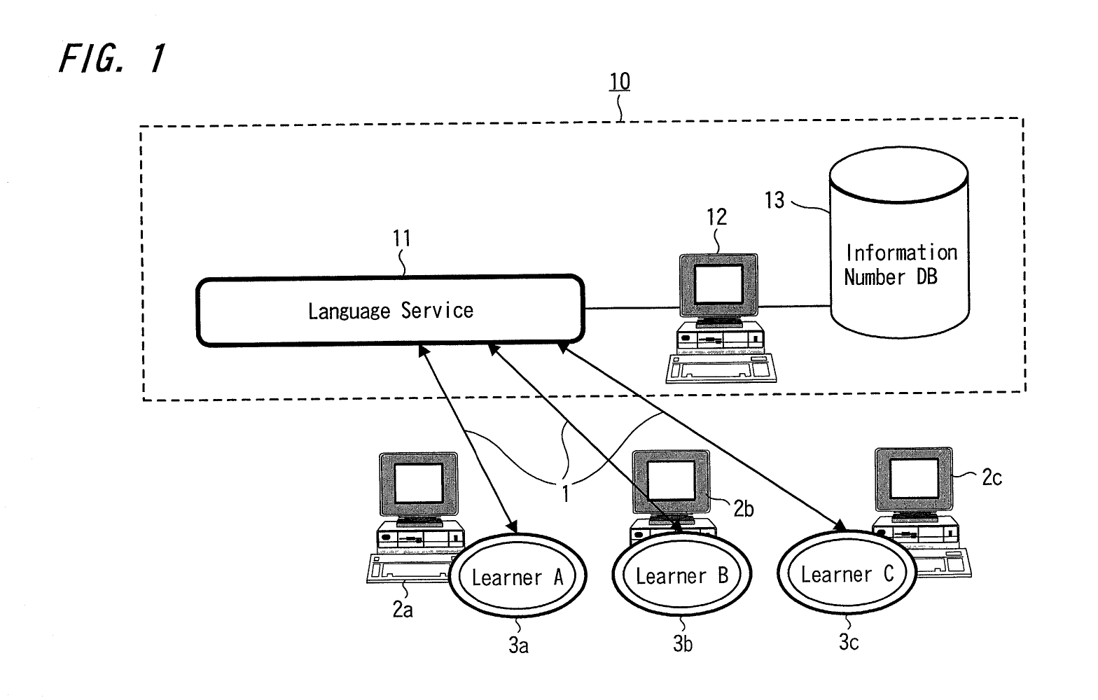

FIG. 1 shows the overall configuration of a learning system in this embodiment. A language learning service server 11 is prepared in a language learning center 10. A center-side terminal unit 12 and a language learning database 13 are connected to the sever 11. The language learning service server 11 carries out a processing for allowing a learner-side terminal unit connected to the server 11 through the Internet to execute language learning based on a learning program stored in the internal storage means (not shown) of the server 11 or the database 13.

Individual learners' terminal units 2a, 2b, 2c, . . . are connected to the language learning service server 11 of the center 10 through predetermined communication lines 1 so as to establish two-way communications, respectively. Then, learners 3a, 3b, 3c, . . . operating the respective terminal units 2a, 2b, 2c, . . . learn a language by operating their respective terminal units.

In this embodiment, the language learning service server 11 allows the learners to execute language learning operations by sending electronic mail to the respective learners or on a predetermined Internet website. Each of the terminal units 2a, 2b, 2c, . . . executes a language learning operation in accordance with the content of the received electronic mail or carries out an operation for displaying the language learning website and executes the language learning operation in accordance with the display of the website. In the following description, an example in which each learner learns a language on the website is shown.

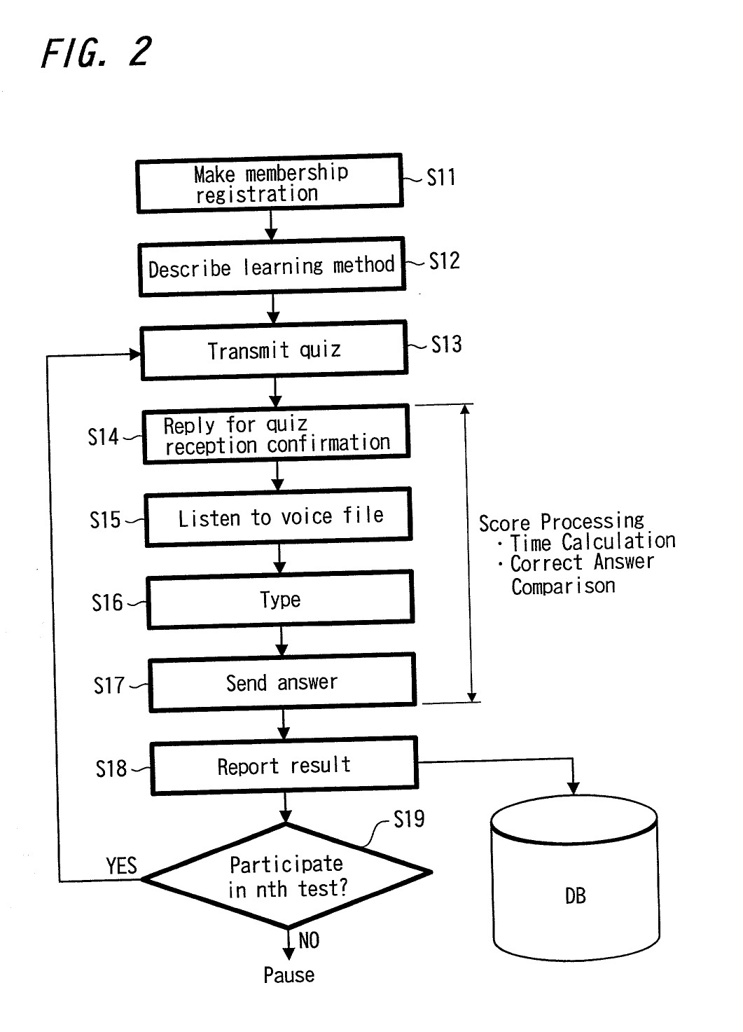

FIG. 2 is a flow chart showing a language learning processing flow on the website prepared by the language learning service server 11. Now, the processing will be described with reference to FIG. 2. First, a user accessing this website carries out a membership registration processing on the website so as to learn a language (in a step S11). By making such a membership registration, each of the learners 3a, 3b, 3c, . . . is given an ID number peculiar to each member. This membership registration processing is not always required to be carried out online, i.e., on the website.

A learning method is described for each registered user (learner) on the website (in a step S12). Then, a quiz is sent to each learner by electronic mail (in a step S13). The quiz sent is assumed to be a relatively short (e.g., about 3 seconds) file of voice data (voice file) with respect to the pronunciations of an English. It is also assumed that the voice file sent is a file predetermined for each executed test such as first, second, . . . test. If the level or learning history of each learner is recognized in advance, the file may be a voice file including a word according to the level or the learning history.

If each learner-side terminal unit receives the voice file as a quiz, the learner-side terminal unit sends electronic mail for confirming the reception of the quiz to the server 11 (in a step S14). At this moment, time data on the reception of the voice file is added to the header of quiz reception confirmation data to be sent. After sending the quiz reception confirmation data, each learner-side terminal unit carries out a processing for outputting voice data included in the voice file as the received quiz. The pronunciation of the word as the quiz is outputted from a speaker connected to the learner-side terminal unit to make the learner to listen to the word (in a step S15).

The learner dictates the word as the quiz and, at the same time, carries out an operation for inputting a sequence of characters constituting the word using a keyboard (in a step S16). When the operation is completed, inputted data is sent to the server 11 as an answer to the quiz (in a step S17). At the time of sending data on this answer, sending time data is added to the header of the answer data. The answer may be sent based on the sending operation of each learner or may be automatically sent when it is determined that key input is completed. If the key input is not carried out for a certain time (relatively short time of about 3 seconds), for example, each learner-side terminal unit may judge that key input is completed.

When receiving the answer data, the server 11 calculates a score based on two elements, i.e., the accuracy of the key input and the speed of the key input. A processing for calculating the key input speed will be described later. The server 11 sends data on the calculation result to each learner-side terminal unit to report the calculation result (in a step S18). The calculation result data is stored in the database 13 connected to the server 11. Then, each learner is asked on the website whether or not the learner is planned to continuously participate in the next learning test (in a step S19). If the learner issues a participation request, the processing returns to the step S13 and a voice file for the next quiz is sent to the learner. If the learner selects not to participate in the next learning test in the step S19, the execution of the learning processing is completed. It is noted that each learner may be charged with a predetermined amount of money every time the learner participates in a test.

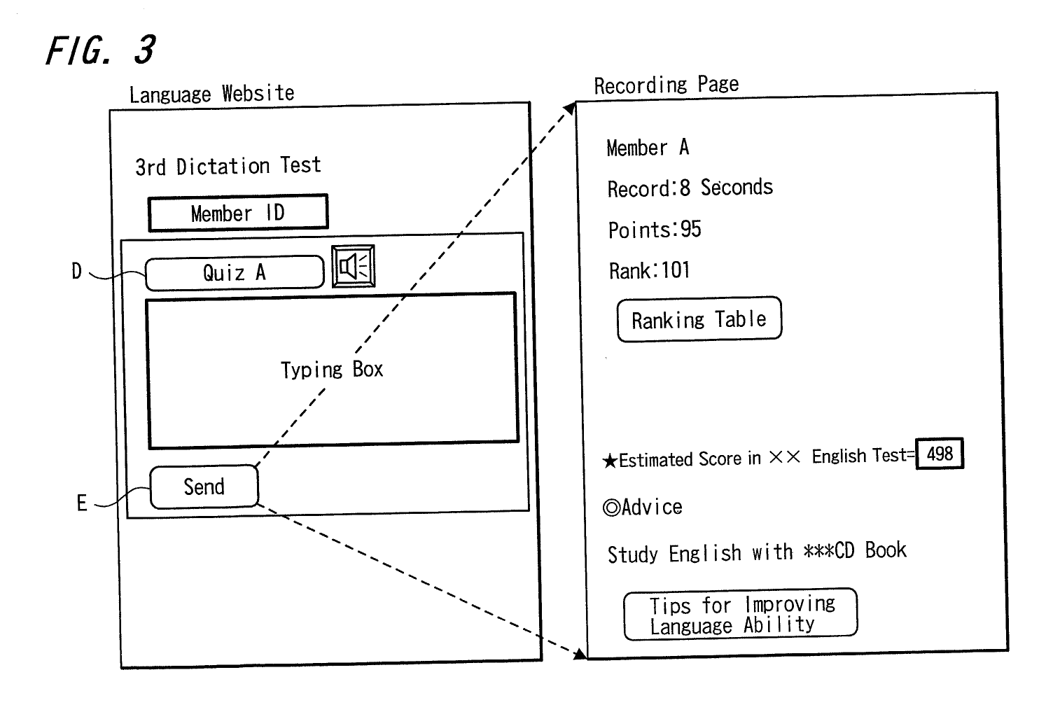

FIG. 3 shows an example of the display of the language learning website in this embodiment. Each learner operates the terminal unit to display this website on a monitor connected to the terminal unit and executes a dictation learning operation. On this website, a box for inputting a member ID number appears. By inputting the learner's ID number in the box, a learning operation for the corresponding member is executed. Further, there is a display D of a button for designating the execution of a quiz. By learner's clicking the position of the display D, the voice of a word as a quiz is outputted. After outputting the voice, if the learner operates the keyboard to type, i.e., input characters, the inputted characters are displayed in a typing box on the screen. Also, in this embodiment, there is provided a display E of a button for executing the sending of an answer to the server, on the lower part of the screen. By each learner's clicking this position, data on the characters displayed in the typing box is transmitted to the server. As already stated above, the character data may be automatically transmitted to the server without operating this send button.

If this send button display E is clicked, the screen is changed to a recording page as shown in the right side of FIG. 3. On this recording page, the result of executed typing is displayed based on a server-side report. In this case, a member name, the recording of time required for key input, a point determined from two elements of the time and accuracy of the key input, and the rank of the member or learner among the learners who executed the quiz are displayed. In addition, there is provided a display position of a button for executing the display of a ranking table. By each learner's clicking the position, a ranking table data transmission request is transmitted to the server. If the server transmits the ranking table data, the corresponding ranking table is displayed.

Furthermore, the server estimates the score of the member or learner in a typical, specific language test such as TOEIC or an English proficiency examination based on the present score and the learning history of the learner and the estimated score is displayed on the recording page. There is also provided a box for giving advice for a learning method with a brief comment based on the determined score. Further, a more detailed learning method may be displayed by each learner's clicking the position at which “Tips for Improving Language Ability”.

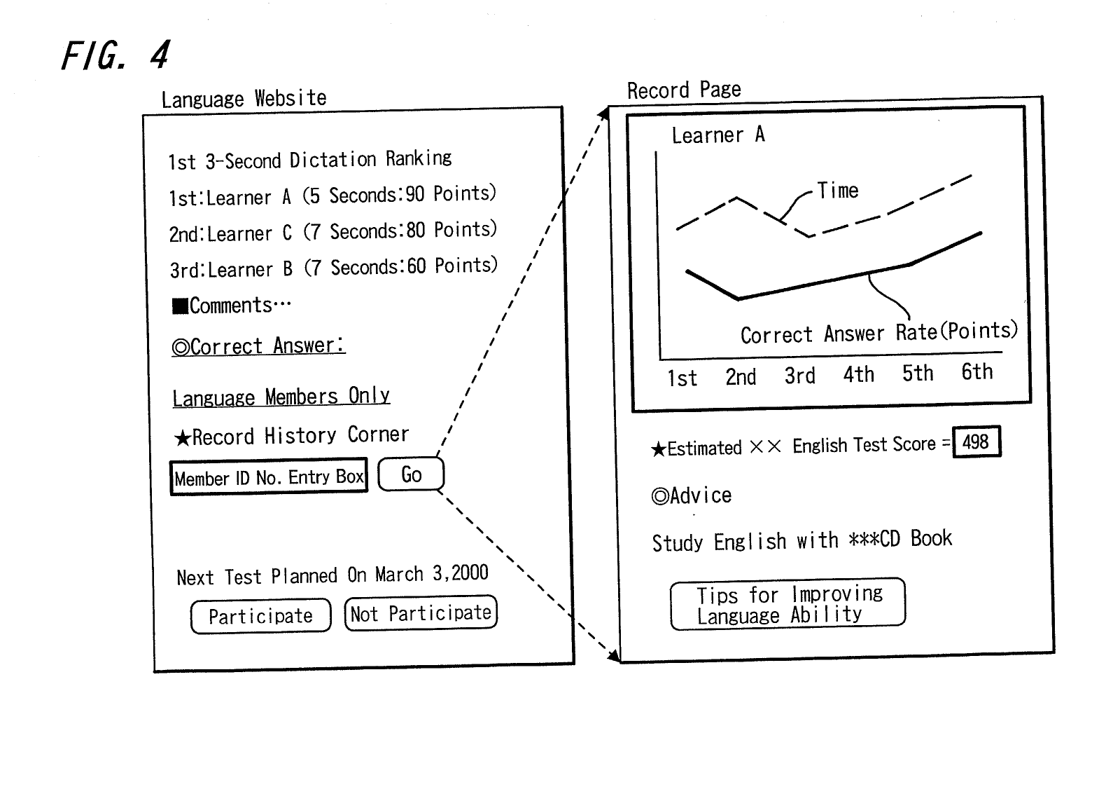

FIG. 4 shows an example of the display of the ranking table. In this example, names, time and scores are displayed from the leaner earning the highest score until a predetermined lower rank in this order. There is also a box for displaying a correct answer to the present quiz. In addition, by inputting the member ID number of each learner in a box displayed as “SCORE HISTORY CORNER”, the history of the records of the learner for the respective quizzes can be displayed. The right side of FIG. 4 shows an example of the record history. Time required for answering each test and correct answer rate (point) are shown in a chart and the estimated score of a specific language test is displayed, as well.

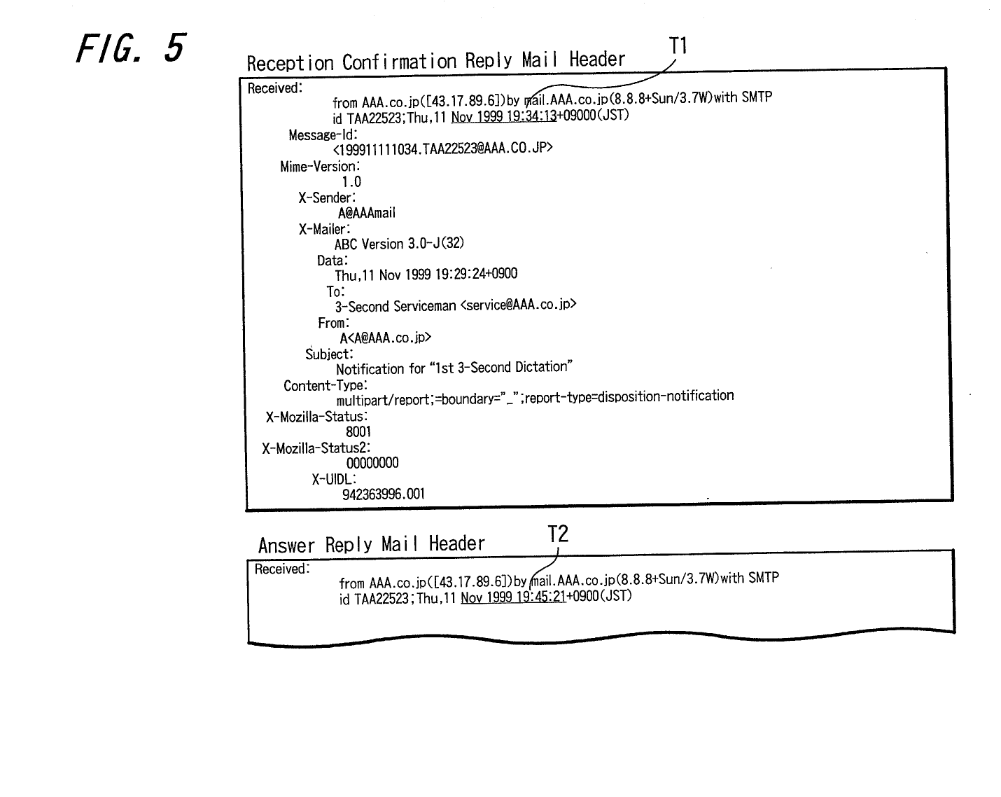

FIG. 5 shows an example of the configuration of a mail header constituting reception confirmation reply data sent from each learner-side terminal unit in the step S14 in the flow chart of FIG. 2 and an example of the configuration of a mail header constituting answer reply data sent from the learner-side terminal unit in the step S17. Data T1 on the time of the day at which the terminal unit received the data transmitted from the server is added to the header of the reception confirmation reply mail. Also, data T2 on the time of the day at which this electronic mail was sent from the terminal unit is added to the header of the answer reply mail. Actual answer data is transmitted to a portion (not shown) continuous to the header of the answer reply mail shown in FIG. 5.

In this example, if receiving these mails, the language learning service server 11 of the center 10 carries out a processing for detecting the time difference between the reception time-of-the-day data T1 included in the header of the reception confirmation reply mail and the sending time-of-the-day data T2 included in the header of the answer reply mail. The server 11 determines that the time difference obtained by this detection processing is time required for the relevant learner to type the word of the quiz and uses the time difference as one of the elements for the calculation of a score (point) as already described above.

In this way, the server 11 determines the time required for each learner to input characters based on the time difference of time-of-the-day information included in the data received by the center 10 side, puts a score (point) based on the determined input time and typing accuracy. By doing so, compared with a case of determining the language ability of each learner based merely on typing accuracy, it is possible to determine the language ability of each learner more accurately. In this case, the time required for each learner to input characters is determined from the time difference of the time information included in the data received on the center 10 side. As a result, it is not necessary for each learner-side terminal unit to measure time required for inputting characters. Namely, it suffices that each learner-side terminal unit executes a processing for outputting the received voice file and a processing for transmitting information on characters inputted after outputting the voice without the need to execute a time measurement processing. The learner-side terminal unit can lighten a processing burden.

Further, since the center entirely carries out the processing for the determination of the time required for inputting characters, it is possible to decrease the probability of the occurrence of errors for the determination of the time, whereby it is possible to make a determination with uniform processings, to accurately determine typing time and to accurately determine the score of each learner.

In addition, by displaying the rank of each learner, the estimated score of a specific language examination, learning advice and the like based on the score calculated from the determination, each learner can efficiently learn a language.

While the time required for each learner to type characters is determined from the time-of-the-day information included in the voice file confirmation reply data and the time-of-the-day information included in the answer reply data in the above-stated embodiment, the time required for each learner to type characters may be determined by other processings. To be specific, if each learner-side terminal unit receives a voice file, for example, a voice in the received file may be instantly outputted from a speaker. By doing so, it is possible to determine time required for each learner to type characters if time required since the center transmits the voice data until the answer data is sent can be determined. Thus, the typing time may be determined from the difference between the time at which the center sent the voice file and the time at which the center received the answer data. It is noted, however, that the accuracy of the determined time is more improved if the time-of-the-day information included in the voice file confirmation reply data as in case of the processing described in the above embodiment.

Furthermore, if time since each learner-side terminal unit receives a voice file until the received voice file is opened and outputted from the speaker is not fixed, time required for each learner to type characters may be determined from the difference between the time of the day at which each terminal unit opens the voice file and outputs the voice file from the speaker and the time of the day at which a character input operation is completed.

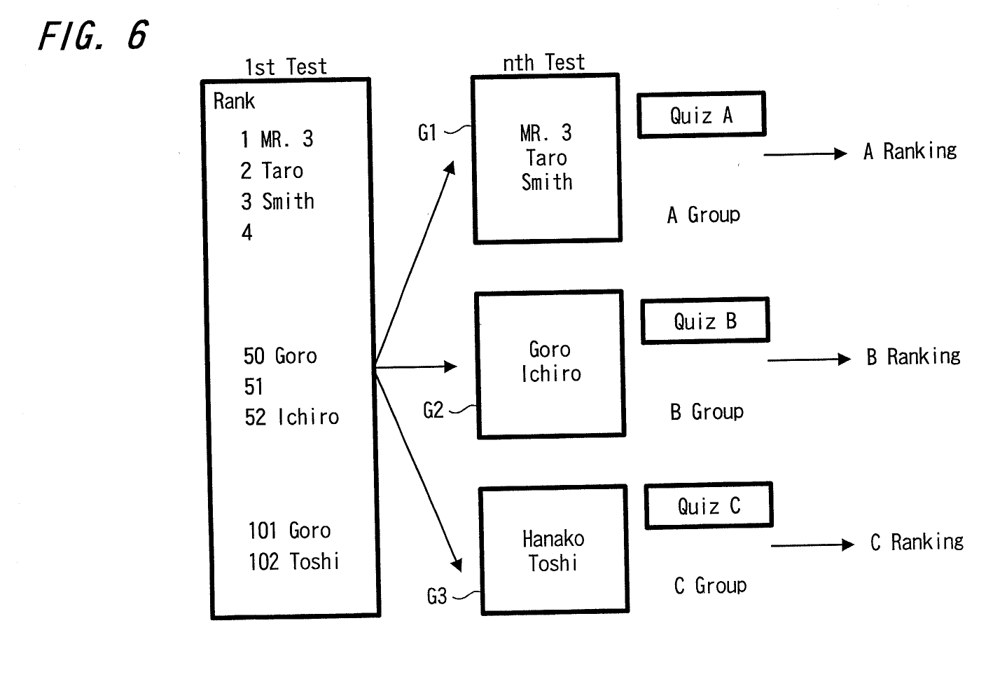

Moreover, if a language learning operation is executed by the processings in this embodiment under the control of the center, the respective learners may be classified into a plurality of groups and each group may select a voice as an appropriate quiz (word) based on the ranking data on the respective learners stored in the database 13 on the center 10 side. FIG. 6 shows an example of this grouping. For example, learners ranking first to 49th in the first test (or a predetermined number of tests) are classified into A group G1, those ranking 50th to 99th is classified into B group G2 and those 101st to last are classified into C group G3. After classifying the learners into groups, optimum quizzes (words) may be selected for the respective groups and the test may be executed. In addition, after the grouping, if the ranks of learners are determined, ranks in the respective groups are displayed. By thus grouping the learners, it is possible to carry out an appropriate learning processing according to the language ability of each learner.

Alternatively, the learners may be grouped according to schools, companies, regions or the like to which they belong instead of the rank-basis grouping stated above.

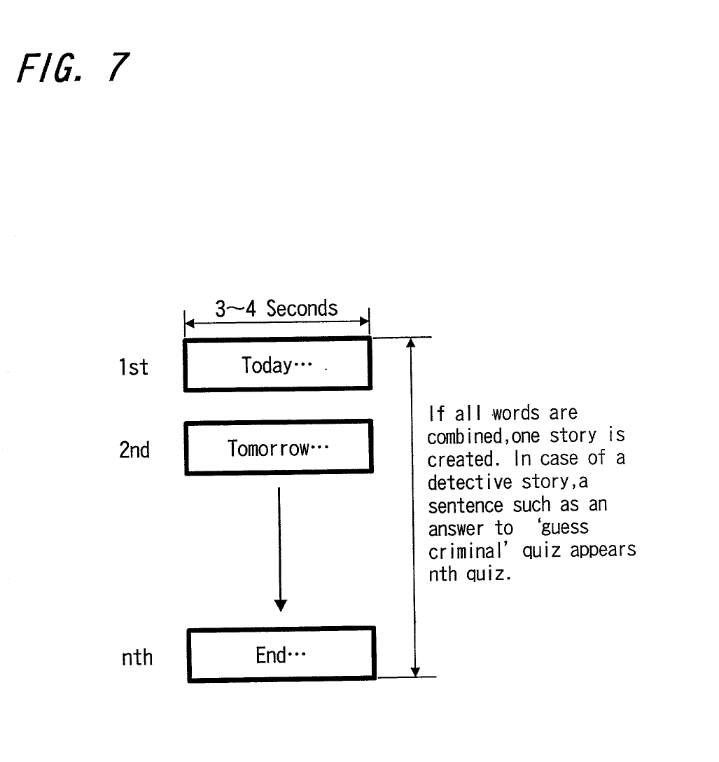

Further, the words in quizzes given to the learners in the respective tests may be associated with one another to some extent. As shown in FIG. 7, for example, if first to nth tests (where n is an arbitrary number) are executed, each learner dictates a short word of about 3 to 4 seconds in each test. If the respective words are combined into one story, e.g., a detective story, then a ‘find-a-criminal’ quiz may be executed after the completion of the final nth quiz so as to facilitate continuing the dictation learning.

In the above-stated embodiment, each learner accesses the Internet website and the language learning operation is executed on the website. Alternatively, without accessing the website, the same learning operation may be executed by exchanging electronic mail between the center and each learner's terminal unit. In that case, a necessary processing program may be transmitted to the learner's terminal unit in advance, and the same learning screen as that appearing when the website is accessed, may be displayed by the execution of the program. After the screen is displayed, the voice file serving as a quiz sent by electronic mail may be outputted and character information inputted by the execution of the quiz may be sent back by electronic mail.

Additionally, in the above-stated embodiment, description has been given while taking the application of the present invention to the English learning system as an example. It goes without saying that the present invention is applicable to other systems for making learners learn other languages through the same processings.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A remote learning method comprising the steps of:
transmitting voice data stored in a language learning voice file on a center side to a terminal of each learner through a predetermined communication line;
if voice in the voice data received by said terminal is outputted and then an operation for inputting characters corresponding to the voice is carried out, transmitting reply data generated based on the input operation for the corresponding characters to the center through said communication line; and
totalizing a learning ability of said learner from time required since said voice data is transmitted from said center until said reply data is transmitted and a correct answer rate of said character input operation.

2. A remote learning method according to the present invention, wherein
the time required since said voice data is transmitted until said reply data is transmitted is determined from a difference between time at which said voice data is opened by said terminal and time at which said reply data is transmitted.

3. The remote learning method according to claim 1, wherein
determination of the time since said voice data is transmitted until said reply data is transmitted is made based on a difference between sending time included in confirmation data transmitted from said terminal to confirm that said terminal received said voice data and sending time included in said reply data.

4. The remote learning method according to claim 1, comprising a step of determining a rank of said learner by totalization by said center, and transmitting ranking information to said terminal.

5. The remote learning method according to claim 1, comprising a step of estimating one of a score of said learner in a predetermined test and a rank of the learner in the predetermined test, and transmitting one of the estimated score and the estimated rank to said terminal.

6. The remote learning method according to claim 1, comprising a step of forming a learning history of the learner into a database by said center, and selecting voice data transmitted to said terminal based on a learning history of each learner.

7. A remote learning control apparatus comprising:
a voice file storing language learning voice data;
communication means for transmitting the voice data stored in said voice file, and receiving answer data for said voce data, the answer transmitted through said communication line; and
control means for determining a learning ability of a learner receiving said voice data, from time since the voice data transmitted from said communication means reaches the learner until said communication means receives answer data and from a correct answer rate of said answer data, and for totalizing the determined learning ability.

8. The remote learning control apparatus according to claim 7, wherein
determination of said control means as to the time since the voice data transmitted from said communication means reaches the learner until said communication means receives answer data is made based on a difference between sending time included in confirmation data transmitted to confirm that the learner received the voice data transmitted by said communication means and sending time included in said answer data.

9. The remote learning control apparatus according to claim 7, wherein
said control means determines a rank of the learner from totalized data, and controls said communication means to transmit ranking information.

10. The remote learning control apparatus according to claim 7, wherein
said control means estimates one of a score of the learner in a predetermined test and a rank of each learner in the predetermined test, and controls said communication means to transmit one of the estimated score and the estimated rank.
